(19) United States
(12) Patent Application Publication
(10) Pub. No.: US 2005/0097177 A1
(43) Pub. Date: May 5, 2005

(54) Business process for improving electronic mail

(76) Inventors: William E. McUmber, Rives Junction, MI (US); Marilyn Wulfekuhler, Lansing, MI (US)

Correspondence Address: HARNESS, DICKEY & PIERCE, P.L.C., P.O. BOX 828, BLOOMFIELD HILLS, MI, 48303, US

(21) Appl. No.: 10/978,871

(22) Filed: Oct. 29, 2004

Related U.S. Application Data
(60) Provisional application No. 60/516,084, filed on Oct. 31, 2003.

(51) Int. Cl. G06F 15/16

(52) U.S. Cl. 709/206

(57) ABSTRACT

A business process for effectively sending, receiving, and managing electronic mail over computer networks is provided. Problems of unsolicited, fraudulent, and malicious email are solved by the new process by providing the following capabilities which are absent in current electronic mail exchanges: Definitive identification of the sender, definitive identification of the receiver, precise recording of all email exchanges, preventing third party eavesdropping on email, and ensuring that senders conform to a set of rules disallowing unsolicited, fraudulent, and malicious email. The new process is easily integrated into existing processes, and does not preclude email communication with others who do not employ the new process.

### CROSS-REFERENCE TO RELATED APPLICATIONS

This application claims the benefit of U.S. Provisional Application No. 60/516,084, filed on Oct. 31, 2003 The disclosure of the above application is incorporated herein by reference.

### FIELD OF THE INVENTION

The present invention relates to processes for businesses to effectively send, receive, and manage electronic mail over networks, including the Internet and private networks. Current email has a number of shortcomings that render it cumbersome or risky for many business operations. The present invention solves those problems.

### BACKGROUND

As recently as fifteen years ago, Electronic Mail (email) had little more than “toy” status in most organizations. From that time until the present, business has steadily increased its reliance on email, weaving it into almost every business process so that today, email is essential to the execution of business operations. Email is so important that when it is unavailable to an organization, even for a short period of time, operations are severely hampered. For example, the Melissa Virus released on the Internet in April of 1999 (CERT Advisory CA-1999-04) was serious enough that EDS, Ford, and many other companies both large and small temporarily stopped their email servers. The subsequent disruption severely hampered business operations and made international news. Today, email plays a much more critical role in the execution of business processes worldwide than it did even in 1999.

Email is currently based on the SMTP protocol defined in the Internet Engineering Task Force (IETF) Request for Comments (RFC) 821 and RFC 822. SMTP was originally designed for simple 7-bit transfers of plain text messages across a TCP/IP link using port 25. ESMTP (Extended SMTP) and Multipurpose Internet Mail Extension (MIME) added the ability to transfer almost any kind of data in an email message, greatly enhancing the utility of email for business operations. However, a number of weaknesses inherent in the original protocol specification are causing serious problems. For example, the means by which email servers identify each other during a message exchange can lead to misidentification of both the sending and receiving parties. The result can be the exchange of email between unintended participants, or even intentional spoofing, the process of falsifying one's identity.

FIG. 1 shows the operation of a typical SMTP email server. The sender for this example is named abc.com and the receiver is xyz.com. Person “smith” is sending email to person “jones”. Server 1 contacts the receiving server 2 over the Internet on TCP port 25. Server 2 responds to the connection with the message 3 “220 ready”. Sender 1 declares its identifying information message 4. Message 4 is a typical place for spoofing to occur. Server 1 next tells server 2 from whom the email is coming in protocol message 6. Subsequently, server 1 tells the receiver who the intended recipient(s) of the message are in protocol message 8 even though the body of the email also usually contains addressing information. If server 2 accepts the recipient, it replies with protocol message 9. Server 1 sends a DATA message 10 to Receiver 2 upon which Receiver 2 tells Sender 1 in message 11 to start mail. Server 1 then sends the text of the message in a series of interactions 12 ending in a data termination sequence. The server 2 acknowledges receipt of the email with response 13 and server 1 terminates the connection with message 14.

Spoofing is currently not difficult, and has become widespread due to the economic incentives associated with sending unsolicited bulk email (spam). The addressing information in message 8 need not agree with addressing information placed in the exchanged data 12 later in the interaction. This is a source of spoofing in traditional email systems. Furthermore, there is no reliable way for either the sending or receiving server to verify the identity of the other party with absolute certainty. For example, sender abc could have pretended to be a different server in messages 4 and 6, or receiver xyz could have pretended to be a different server in message 3.

Many email server programs have had features added over the years to attempt to determine if the sender is “valid”. For example, the name declared by sender 1 in message 4 can be compared to the name obtained by reverse lookup of server 1's IP address. Various schemes involving tables of “acceptable” servers have also been tried. Reverse IP lookup only works if the Domain Name Server (DNS) records are correct and if there is sufficient previous experience with the sending server that one can be reasonably certain of the message contents. Similarly, tables of acceptable servers only work in situations where the receiver has previous knowledge of the sender. More recently, some organizations have added special records to their DNS configurations to enable a recipient to determine if the sender's identity is valid. For well-known domains such as aol.com, this may work if the receiver is equipped to handle the extra information, but a spammer (one who sends unsolicited bulk email) can also put these records in his DNS, following all the identity rules, and still send spam. Only after a bad email has been received can the recipient decide this is an address from which not to accept email, by which time the spammer has often moved on to a different IP address.

To enable forwarding of email, the email addressing standard allows a sending sever to attempt to pass a message through a server other than the intended recipient's server. For example, it is possible to send email destined for an arbitrary addressee to the whitehouse.gov server, which should forward the message to the final destination. This was a “feature” of the original RFCs, intended for email routing in an era when interconnectivity was lower, however relaying also enables a bulk sender of unwanted email to partially hide his identity by using a third party. The volume of bulk unauthorized relaying has grown to the point where most servers now check for relaying attempts and only accept relayed messages in a small, defined set of cases.

Spoofing and relaying are only two of many serious problems inherent in the basic definition and practice of email exchange. Some of the greatest deficiencies have been pointed out through the exponential growth of spam, defined as unwanted bulk email. Since anyone can send anything to anyone at any time under current standards, the operator of an email server has little control over the received email. Similarly, spammers, those who send spam, can easily set up servers to cheaply send bulk email to as many servers as they can find. Since spoofing is easy, it is often difficult to determine who is sending the message. Further, some email servers on the internet are still open to relaying, which enables a spammer to further hide his identify by relaying through a server that otherwise would not be sending spam. If the identity of the spammer is unknown or hard to determine, keeping tables of unacceptable senders, as mentioned earlier, is extremely difficult. Even if the identity of the sender is known, what he is sending is not known and hence can be valid email, spam, or have malicious intent. Consequently, an entire industry has arisen to send spam to every email server on the Internet.

Not all spam is “harmless” advertising. Some spam consists of messages intended to perpetrate fraud by means such as including web clickable links that mimic links to well known sites when, in fact, they are actually links to look-a-like sites. The purpose of the fake site is often to collect personal information useful for identity theft.

Not all unwanted email contains messages and pictures. It is possible to send executable procedures and programs that have malicious intent either as regular programs or encoded in macro-procedure languages. The Melissa worm mentioned earlier is an example. When received and (often unwittingly) executed, viruses and worms not only spread through local networks, but also spread rapidly across the Internet. The reason viruses and worms spread is the same reason spam is a problem: one can not always be sure of the behavior and intent of the email sender, either because that sender is previously unknown or their identity cannot be positively established at the time the email is received. Consequently, email is accepted from almost any sender.

Just as an entire industry has arisen for sending spam, an entire industry has arisen to combat the spam problem. The overwhelming majority of spam control techniques attempt to process email after receipt. Detecting spam after receiving it is difficult and destined to failure. Current efforts for spam control rely on filtering or classification of messages into spam versus non-spam by analyzing a message's contents. This approach can never achieve 100% accuracy because it is subject to both false positives and false negatives. Already, some spam email consists solely of an image containing the spammer's message as a graphic image. Filtering software finds this virtually impossible to classify because it requires interpretation of a visual image.

Even if it is assumed that spam filtering works reliably, the network resources and email servers still incur additional load to handle the spam messages. In addition, the labor costs of sorting through and discarding spam, or of verifying that a message tagged as spam by filtering software should indeed be discarded are immeasurable. It has been estimated that spam constitutes up to ¾ of the email received. The cost of handling this unwanted email is high and introduces additional costs to every process connected to email. Perhaps the greatest risk with filtering for business lies in incorrectly classifying a good message as spam. The consequences of a lost critical document severely impact the use of email for such correspondence. The anti-spam industries' response to this problem has been to err on the side of “safety” by allowing more spam through. Clearly, this defeats the purpose of filtering.

Recently, legislative responses to spam have been proposed, and in some jurisdictions, enacted. Responses range from simply making the sending of spam illegal, to more complex schemes for bounties on spammers. Some states have already passed laws to attempt to block spam by various methods, such as requiring an “ADV:” tag in the email subject line in order to make filtering easier. Enforcement difficulties aside, legislative measures will ultimately also fail because a spammer can easily circumvent the laws by moving his operation to a different jurisdiction, such as a country that is friendly to spamming, without having to have a physical presence in that country.

Although spam is a huge and expensive problem, it is not a first cause, but rather a symptom of weaknesses in the business process for exchanging messages electronically over the Internet. Problems with the ESMTP protocol, largely inherited from the original SMTP protocol, also play a major role in hampering effective exchange of electronic messages. Business processes need additional capabilities that are difficult or impossible to obtain with current email. These include:
1. Definitively determining the identity of the sender
2. Verification of the identity (by the sender) of the receiver
3. Recording precisely the time and date of the message exchange

4. Hiding message contents from eavesdroppers

5. Knowing the sender is “well-behaved” in email practices.

### SUMMARY OF INVENTION

As the use of electronic mail in business and elsewhere increases, the shortcomings of the original processes and standards for sending and receiving email become more and more evident. The present invention uses a semi-closed email Community whose members agree to abide by a set of conduct rules to provide predictability and confidence for receivers of email from members with whom the receiver would otherwise be unfamiliar. Mail flows from the sender to a mail portal, which contacts another mail portal at the receiving end. The receiving mail portal verifies the sender's compliance with conduct rules through a third conformance server. If the sender is within acceptable compliance with the conduct rules, the portal accepts the mail, forwarding it to the receiver. The invention includes the provision for monitoring sender traffic to ensure compliance with the conduct rules. All transmissions by sender, receiver, and to and from the conformance server are over secure channels to increase confidence in the exchanges.

One aspect of the present invention would enable the receiver to determine if there is a business relationship with the sender, and hence his intentions. This would help stop spam and email propagated by viruses and worms. A different aspect of the present invention increases security of exchanges, especially in critical situations such as placing purchase orders. For example, if a sender unwittingly sends a sensitive document to the wrong receiver, the consequences can be significant. Verification of sender identity by a receiver is not very useful if the behavior of the sender is not also known. Another aspect of the present invention provides a way of judging if the sender is likely to send email not desired. Yet another aspect of the present invention has similar utility, but could also be used to precisely reconstruct a sequence of message exchanges for verification of communications (such as non-repudiation) or to trace a problem. For example, in the event that someone did send an email virus or worm, the exact identity and time of the exchange could be established. Over a series of servers with such capability, the origin of the message could be established. The ability to trace such a problem to its origin would both deter such actions and enable damages to be established. All of the capabilities described above are manifested in the current invention, as described below.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 describes the sequence of messages during an email exchange using the current SMTP email protocol.

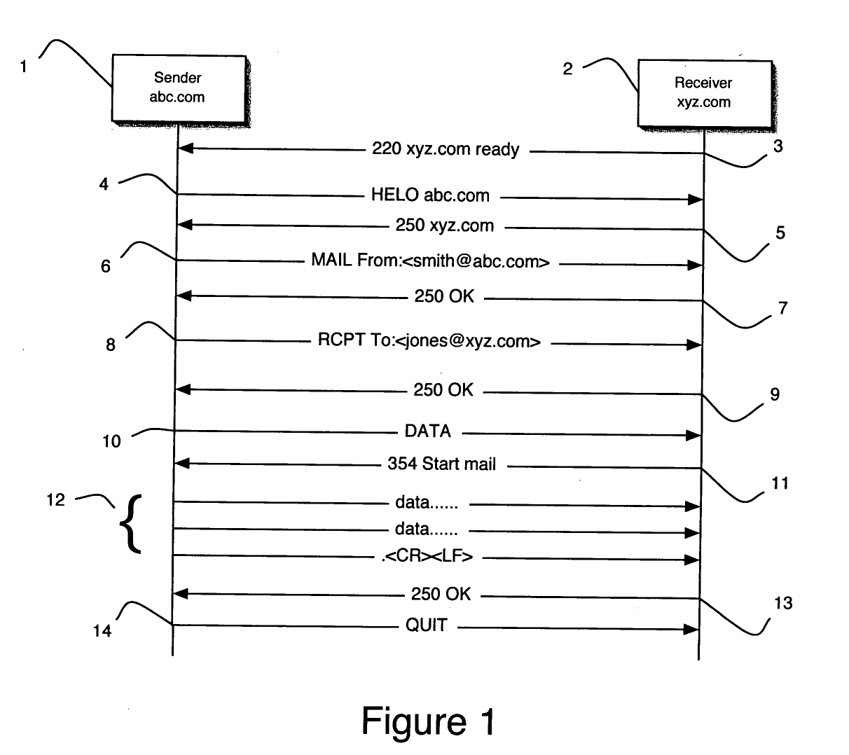

FIG. 2 describes an overall view of the major components of the current invention.

FIG. 3 describes the sequence of messages during an email exchange using the current invention.

FIG. 4 describes a scenario of a user who does not employ the current invention sending an email to one who does employ the current invention.

### DETAILED DESCRIPTION OF THE PREFERRED EMBODIMENTS

The following description of the preferred embodiment(s) is merely exemplary in nature and is in no way intended to limit the invention, its application, or uses.

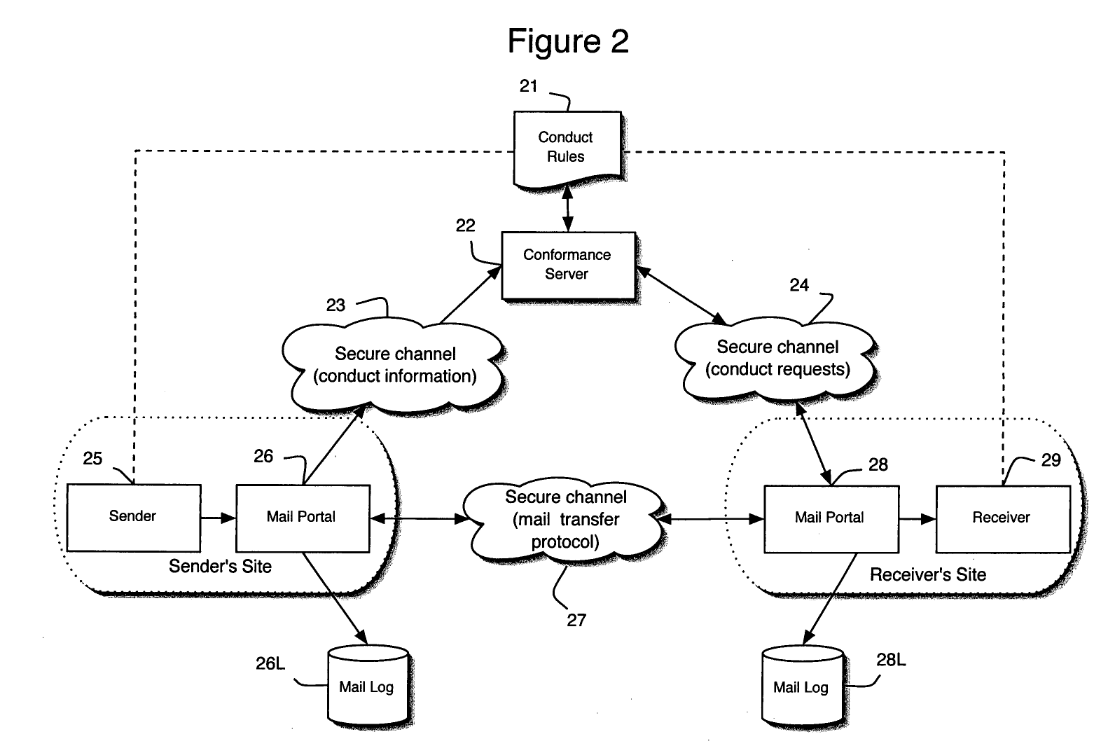

FIG. 2 shows the components of the invention. The exchange of email from sender 25 to receiver 29 occurs through mail portals 26 and 28, which communicate through secure channel 27. The exchange is governed by and predicated upon conduct rules 21. If either sender 26 or receiver 29 is in violation of conduct rules 21 as determined by conformance server 22, the exchange does not take place. Conformance server 22 maintains and mediates the status of sender and receiver with regard to the conduct rules. Mail portals 26 and 28 maintain detailed logs 26L and 28L of the entire message exchange.

Note that FIG. 2 shows sender 25 and mail portal 26 grouped together at the sender's site. They are shown as separate entities but it is important to note that they are not independent. They are tightly coupled and operated together via a secure mechanism so that the mail portal cannot be spoofed by an entity pretending to be the actual sender. Similarly the Receiver 29 and the Receiver's mail portal 28 operate together in a secure way.

Again referring to FIG. 2, when sender 25 wishes to send a message to receiver 29, mail portal 26 is first contacted. Mail portal 26 contacts mail portal 28, which contacts conformance server 22 through secure channel 24 with a request about the conduct of sender 25. If conformance server 22 decides sender 25 is in compliance with conduct rules 21, the exchange proceeds. If sender 25 violates conduct rules 21 during the exchange, by attempting to send spam to receiver 29, for example, mail portal 26 informs conformance server of the conduct rules (21) violation and the exchange is terminated.

The invention embodies a business process that consists of a set of “good conduct” rules combined with technical facilities to enable the process. The business process describes a community of business members, henceforth called Community, all of whom possess the technical facilities of the invention and share agreement to comply with the conduct rules. FIG. 2 shows the components for email exchange between two arbitrary members of Community. The invention does not require senders and receivers to have any prior knowledge of each other prior to an email exchange. The conformance server 22 serves the purpose of informing any member of the compliance status relative to the conduct rules of another member. Members may move in and out of Community at any time without immediate notification of members of Community.

Members of Community share the following characteristics:
They can reliably verify the identity of another member.
They agree to a set of good conduct rules.
All message exchanges are private.
Have recourse for non-complying members.

The rules include a prohibition on sending unsolicited or harmful (e.g., viruses and worms) email. A key provision of the process includes the technical ability to exclude an offending member from Community immediately if a rule is violated.

The invention includes several levels of identifying Community members ranging from individuals to groups larger than one, but smaller than an entire organization, to an individual server, to an entire organization. For example, an organizational member might further require each individual in that organization to be a member. Alternatively, an organization might wish to designate that certain sub-units of the organization each become members, and individuals within the subunits also become members. This would enable a very large company to itself be a member, and also designate that each division of the company were a member. Finally, each individual within each division would also be a member. This would allow levels of differentiation for compliance with rules. Instead of removing an entire large company from Community when only one division violated the rules, only the one offending division would be removed.

Again referring to FIG. 2, a member of Community may be determined to be in violation of the conduct rules 21 at either the sender portal 26, or receiver portal 28, or receiver 29. The sender portal 26 can monitor conformance to the rules 21 as email is sent. Since all communications of the sender portal are logged (26L), the sender portal can examine the history of the sender's behavior, and automatically determine if bulk messages are being sent (an indicator of spam), for example, by an unexpected increase in the number of recipients of the same message. The bodies of the email sent can also be examined before they are sent, and can be compared to characteristics of known spam, and to each other, similar to current spam filters which operate only after the message has been received. If the sending portal 26 detects behavior that is in violation of the conduct rules 21, a message is sent to the conformance server 22 to indicate that the sender 25 is not in good standing, and receivers will no longer accept mail from sender 25. Additionally, the sender mail portal 26 can detect behavior that constitutes a suspicion of conduct rules violation, and in this case rather than immediately eliminating sender 25 from the Community of good standing, a warning is sent to the Conformance Server 22's administrators, who can investigate the detailed logs (26L) to determine whether a violation has in fact occurred.

If unsolicited or malicious email is not detected by the sender's mail portal 26 and gets through to receiver portal 28 or receiver 29, the receiver 29 or receiver portal 28 can report a complaint to the conformance server 22's administrators, who will again investigate using logs 26L and 28L to determine if a violation has indeed occurred. If so, the sender 25 is removed from the Community as before. Recall that a violator can be removed as an individual, a subunit of an organization, or an entire organization.

In some situations the invention processes uses secure (encrypted) channels to exchange data. One possibility is to use Secure Sockets Layer (SSL). While the business process relies on some means of securely exchanging messages, it does not depend exclusively on SSL. Transport Layer Security (TLS), a newer form of SSL, or some as-yet unseen new protocol, if it had the properties described in this invention, could enable the business process. For concreteness, we will henceforth, in this description, assume that an embodiment of the invention uses SSL.

SSL was originally intended for secure web exchanges where the identity of the server is important and where the transaction must be encrypted (such as credit card transactions). The identity of the web server is established with an X.509 certificate, digitally signed by a third party certificate authority. SSL also includes the capability for the web client (the entity making the request) to hold a certificate so that the server can verify the client's identity, although for current web transactions this facility is rarely, if ever, used. In this invention's embodiment, the sender of an electronic mail message assumes the role of the SSL client, requesting the intended receiver's certificate. This establishes the identity of the receiver and as a side benefit establishes keys for the encrypted exchange of email. The receiver of the email, playing the role of the SSL server, can request the identity of the email sender (client role) to verify who is originating the message. The process then proceeds with the receiver contacting a third party conformance server to verify that the sender is still in compliance with the good conduct rules of Community. If this verification succeeds, the receiver can be certain that the email received is not spam and does not contain viruses or worms. The connection from the receiver to the conformance server also uses SSL so that the identity of the email receiver and the conformance server are mutually established.

SSL connections are normally encrypted using keys exchanged during the initial handshake between sender and receiver. Encryption ensures the privacy tamper-free nature of all transactions in the business process.

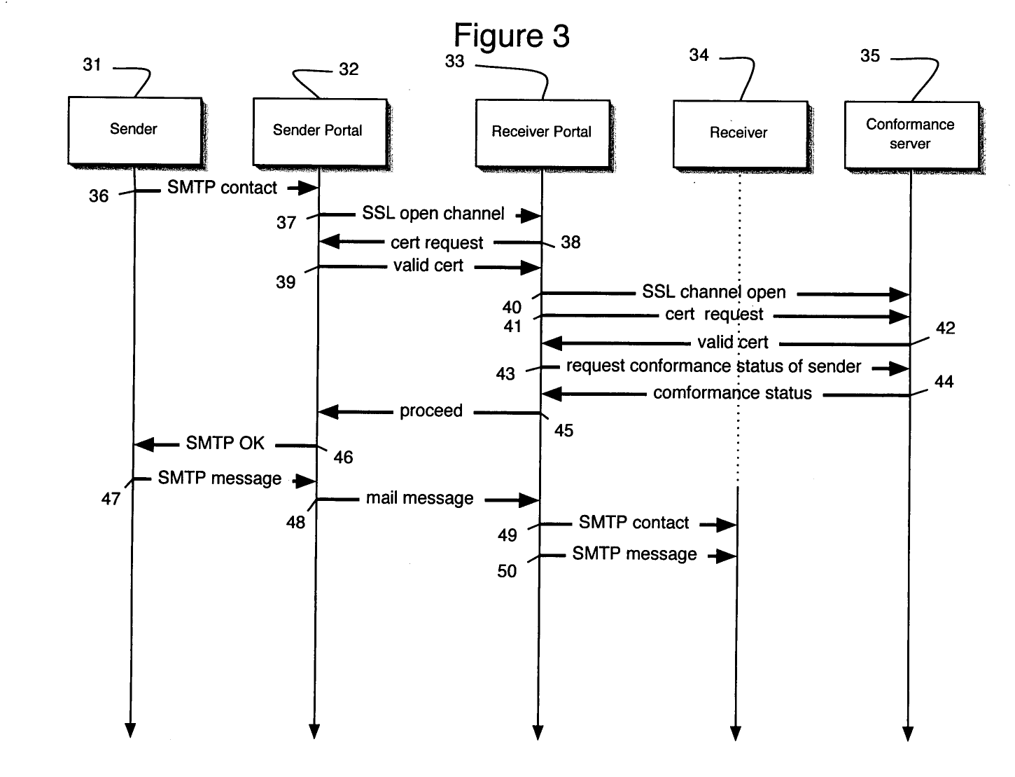

FIG. 3 shows the major events in the embodiment of the current invention for exchange of an email message between a sender and receiver using SSL as the secure channel protocol.

1. Sender 31 contacts sender portal 32 using a standard SMTP protocol message 36.

2. Sender portal 32 contacts receiver portal 33 using SSL open channel message 37.

3. Receiver portal 33 verifies sender portal 32's identity by requesting (38) sender portal 32's X.509 certificate.

4. Sender portal 32 responds (39) with a valid X.509 certificate to identify itself.

5. Receiver portal 33 contacts conformance server 35 using SSL channel open (40) message.

6. Receiver portal 33 requests conformance server 35's X.509 certificate to confirm identity of conformance server (41).

7. Conformance server 35 sends (42) valid X.509 certificate to receiver portal 33.

8. Receiver portal 33 requests (43) conformance status of sender 31 from conformance server 35 with respect to conduct rules.

9. Conformance server 35 sends (44) conformance status to receiver portal 33. (Note: if sender 31 is not in conformance, the email exchange ends at this point).

10. Assuming sender 31 is in conformance, receiver portal 33 tells (45) sender portal 32 to proceed with email exchange.

11. Sender portal 32 concludes email exchange (46, 47) with sender 31.

12. Sender portal 31 sends email message (48) to receiver portal 33.

13. Receiver portal 33 initiates SMTP contact (49) with receiver 34.

14. Receiver portal 33 completes message exchange (49, 50) with receiver 34.

Both sender and receiver portals (32 and 33) log all actions in steps 1 through 14 to mail logs.

The sender portal 32 monitors the content and nature of the email being sent to receiver 34. If it determines that a conformance rule is being violated, such as an unauthorized bulk transfer of email, the sender portal notifies the conformance server 35 of the violation and terminates the email exchange. It is generally agreed that bulk email transfers—spam—can be identified from the sender's end much more easily than at the receiver end. The sender portal will accumulate sending history over a period of time to maintain a profile of the sender 31's email transfer characteristics to ensure compliance with conformance rules. Other members of Community may also contact the conformance server to update a member status when a violation is detected.

In order for a member to be listed in the conformance server's records as being in good standing, the individual, subunit, or organization must agree to a set of business process rules. Violation of conduct rules can result in any or all of the following:
1. Termination of the entire entity's ability to send email within Community.
2. Termination of an individual server's ability to send email within Community.
3. Termination of an individual's ability to send email within Community.

The rules include, but are not limited to:
1. Agreement to not send unsolicited bulk email (spam) to other members.
2. Agreement to not send harmful messages to other members.
3. Agreement that, upon request of a receiver member, a sending member will send no more email to that receiving member.

4. Agreeing that bulk email will not be sent to a member with whom there is no established business relationship.

5. Agreeing that violation of these rules can result in the immediate revocation of the “good standing” status in the conformance server, to last until the situation is resolved.

The above list is not exhaustive, nor is the list a minimum requirement. Individual members may choose to waive certain rules with respect to the conduct of other members.

FIG. 2 shows an embodiment of the invention in which the portal servers (26, 28) are separate from the sender and receiver servers (25, 29); however, an alternate embodiment envisions the sender and its mail portal (25 and 26) combined, as well as the receiver and its mail portal (29 and 28) combined. This is reflected by the dotted oval surrounding the sender and its mail portal labeled “Sender's Site” and the dotted oval surrounding the receiver and its mail portal labeled “Receiver's Site”. If the embodiment were manifested as separate mail servers and mail portals, they would both be tightly coupled and physically located together so that there is no opportunity for falsifying information in the connection between a server and its portal. As noted earlier, SMTP and ESMTP protocols are already in widespread use. To allow for the migration to the current invention process, the current process for sending email must smoothly integrate into the new process of this invention. The means to accomplish this migration is to employ separate mail portal servers as shown in FIGS. 2 and 3, although they are still tightly coupled and interdependent, as mentioned earlier. Each portal has the function of serving as the entry point to Community. A portal handles the technical functions of contacting the destination portal via a secure protocol in order to distribute the email as described earlier. An organization that is a Community member would arrange to have its current SMTP and ESMTP based email servers accept email exclusively from, and pass email only to, the portal associated with that organization. The SMTP standard allows email messages to be sent to an intermediate mail server for final relay to the destination. The portal would appear to be such a relaying server, but would in fact handle the email according to processes described above.

An equally effective embodiment of the invention foresees the sender (or receiver) mail servers and the portal combined on a single server, or even within a single software component. The invention does not rely on the portal being physically separate from the mail server.

Not all email senders will always be within Community. Especially during early deployment of the current invention, email whose origin and trustworthiness may be in question will arrive at the email portal. The portal employs one or more strategies with regard to email coming from outside Community. These include:
1. Reject the email outright with a return message saying the member does not accept email except from members of Community.
2. Accept the email, but mark it clearly in the email header as being untrustworthy. Similarly, email coming from another portal within the trusted community would be marked as “trusted” to differentiate it from non-Community email.
3. Direct the sender to a web site that requires some form of manual identity verification. The intent of manual identification is to ensure that the sender is not an automated process distributing spam.

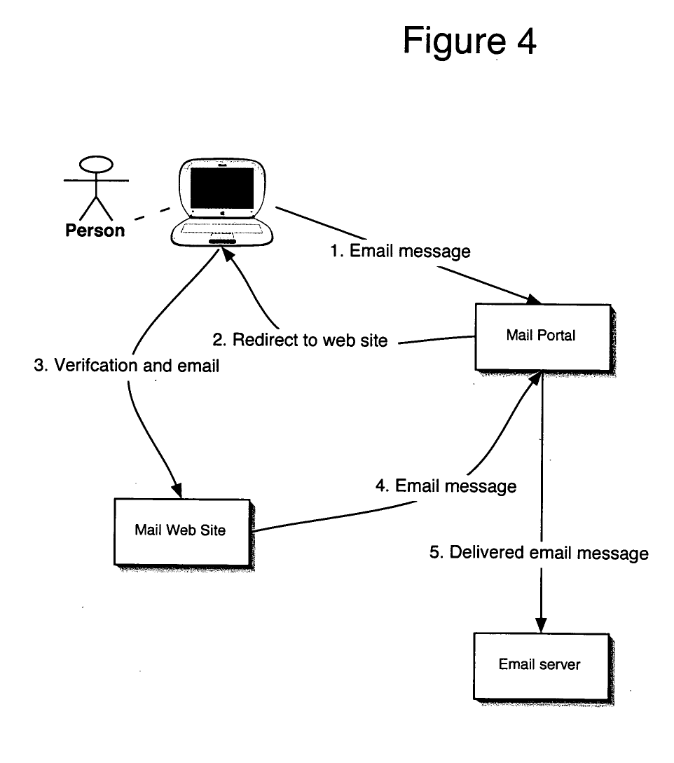

FIG. 4 shows how item 3 above might work. A person who is not a member of Community sends a message to the mail portal that is in Community. The mail portal does not recognize the sender as being a member of Community, and instead of delivering the email, redirects the sender to a web site where they will be asked to verify their identity. Once verified, an email message is sent back to the mail portal, where it is then ultimately delivered.

As an example of why item 3 above is a useful strategy, consider a large retail organization that highly values responses from its individual customers. Perhaps an individual not in the community wishes to send SMTP based email to the customer support section of the large retailer. Assume the individual's Internet Service Provider (ISP) is not a member of Community, hence the individual's email will not arrive securely through a pair of trusted portals. Instead, the retail firm's portal will be contacted directly from the ISP's SMTP server. The portal would then redirect the sender to a web site where a procedure to establish that the sender is a person (as opposed to a program) would be performed. The web site will then forward the authenticated email to the appropriate mail portal.

Note also that members of Community may also send email to members outside the Community via regular email protocols. The fact that an entity employs a mail portal of the current invention does not preclude the entity from also sending email using current protocols.

The description of the invention is merely exemplary in nature and, thus, variations that do not depart from the gist of the invention are intended to be within the scope of the invention. Such variations are not to be regarded as a departure from the spirit and scope of the invention.

1. A system for processing electronic messages, comprising:
verification entity configured to verify the identify of a party associated with an electronic message;
good-standing entity that maintains a data store of parties who are in compliance with predetermined rules;
message delivery mediation entity receptive of first information from said verification component and configured to inhibit delivery of said electronic message if the identity of said party is not verified;
said message delivery mediation entity receptive of second information from said good-standing component and configured to inhibit delivery of said electronic message if said party is not in compliance with said predetermined rules.

2. The system of claim 1 wherein said verification entity is configured to verify the identity of a sending party associated with said electronic message.

3. The system of claim 1 wherein said good-standing entity is configured to assess whether a sending party associated with said electronic message is in compliance with said predetermined rules.

4. The system of claim 1 wherein said verification entity employs a cryptography mechanism that protects the communication channel between a sending party and a receiving party both associated with said electronic message.

5. The system of claim 1 wherein said electronic message is an e-mail message.

6. The system of claim 1 wherein said good-standing entity includes a subscription mechanism whereby parties are added to said data store.

7. The system of claim 1 wherein said good-standing entity includes a compliance testing mechanism that certifies parties who are in compliance with said predetermined rules.

8. The system of claim 1 wherein said good-standing entity includes a revocation mechanism that alters information in said data store with respect to parties who are not in compliance with said predetermined rules to cause said message delivery mediation entity to inhibit delivery of said electronic message.

9. The system of claim 1 wherein said verification entity is configured to verify the identity of a receiving party associated with said electronic message.

10. The system of claim 1 wherein said good-standing entity is configured to assess whether a receiving party associated with said electronic message is in compliance with said predetermined rules.

11. The system of claim 1 wherein said message delivery mediation entity maintains a log of electronic messages sent and received thereby associating non-repudiation information with said electronic messages sent and received.
